(19) United States
(12) Patent Application Publication
(10) Pub. No.: US 2023/0161935 A1
(43) Pub. Date: May 25, 2023

(54) METHOD OF GENERATING A DIGITAL TWIN OF THE ENVIRONMENT OF INDUSTRIAL PROCESSES

(71) Applicant: Watlow Electric Manufacturing Company, St. Louis, MO (US)

(72) Inventors: Hanwen YUAN, St. Louis, MO (US); Sanhong ZHANG, Ballwin, MO (US); Grant BREWER, St. Louis, MO (US); Mengkai XU, Boston, MA (US)

(73) Assignee: Watlow Electric Manufacturing Company, St. Louis, MO (US)

(21) Appl. No.: 17/989,747

(22) Filed: Nov. 18, 2022

Related U.S. Application Data
(60) Provisional application No. 63/281,952, filed on Nov. 22, 2021.

(51) Int. Cl. G06F 30/27; G05B 23/02

(52) U.S. Cl. CPC G06F 30/27; G05B 23/0254; G06F 2119/08

(57) ABSTRACT

A method of generating a digital twin of an environment includes generating one or more mathematical-based variables based on a mathematical model of the environment and sensor data from one or more sensors of the environment, generating one or more machine learning-based variables based on a machine learning-based model of the environment and the sensor data, and stacking the one or more mathematical-based variables and the one or more machine learning-based variables based on a meta-learning model to generate a machine learning input for predicting a performance characteristic of the environment.

### CROSS-REFERENCE TO RELATED APPLICATION

This application claims priority to U.S. provisional application No. 63/281,952 filed on Nov. 22, 2021. The disclosure of the above application is incorporated herein by reference.

### FIELD

The present disclosure relates to a method of generating a digital twin of an environment, such as a semiconductor processing system.

### BACKGROUND

The statements in this section merely provide background information related to the present disclosure and may not constitute prior art.

In a variety of industrial processes (e.g., a semiconductor processing environment), operators often monitor various components to identify and diagnose potential issues and anomalies associated therewith. For example, locations along a conduit that are excessively warm/cool may correspond to undesirable performance characteristics of the semiconductor processing environment. To monitor the components, operators may employ machine learning models that predict performance characteristics based on a digital twin that virtually replicates the semiconductor processing environment. However, creating the digital twin is a time-consuming and resource-intensive process requiring numerous sensors and the collection of large amounts of data over a long period of time. These issues with creating digital twins, among other issues, are addressed by the present disclosure.

### SUMMARY

This section provides a general summary of the disclosure and is not a comprehensive disclosure of its full scope or all of its features.

The present disclosure provides a method of generating a digital twin of an environment comprising generating one or more mathematical-based variables based on a mathematical model of the environment and sensor data from one or more sensors of the environment, generating one or more machine learning-based variables based on a machine learning-based model of the environment and the sensor data, and stacking the one or more mathematical-based variables and the one or more machine learning-based variables based on a meta-learning model to generate a machine learning input for predicting a performance characteristic of the environment.

The following paragraph includes variations of the method for generating a digital twin of the environment of the above paragraph, which may be implemented individually or in any combination.

In one form, the mathematical model is a thermodynamic model of the environment. In one form, the machine learning-based model is one of a random forest regression model and a gradient boosting regression model. In one form, the gradient boosting regression model is a support vector machine regression model. In one form, the meta-learning model is a gradient boosting regression model. In one form, the sensor data indicates a gas flow rate, a gas temperature, a conduit temperature, a heater characteristic, a conduit heat flux, or a combination thereof. In one form, the one or more mathematical-based variables and the one or more machine learning-based variables indicate an upstream temperature and a downstream temperature relative to a sensor from among the one or more sensors configured to generate the sensor data.

The present disclosure provides a method including generating one or more mathematical-based variables based on a mathematical model of an environment and sensor data from one or more sensors of the environment and generating one or more machine learning-based variables based on a machine learning-based model of the environment and the sensor data. The method includes stacking the one or more mathematical-based variables and the one or more machine learning-based variables based on a meta-learning model to generate a machine learning input, where the machine learning input includes a material deposit characteristic machine learning (MDCML) input, a sensor characteristic machine learning (SCML) input, a heater characteristic machine learning (HCML) input, or a combination thereof. The method includes predicting a performance characteristic of the environment based on the machine learning input, where the performance characteristic of the environment includes an amount of material deposit within a conduit of the environment based on the MDCML input, a sensor state of the one or more sensors based on the SCML input, a heater state of a heater of the environment based on the HCML input, or a combination thereof.

The following paragraph includes variations of the method of the above paragraph, which may be implemented individually or in any combination.

In one form, the mathematical model is a thermodynamic model of the environment. In one form, the machine learning-based model is one of a random forest regression model and a gradient boosting regression model. In one form, the gradient boosting regression model is a support vector machine regression model. In one form, the meta-learning model is a gradient boosting regression model. In one form, the sensor data indicates a gas flow rate, a gas temperature, a conduit temperature, a heater characteristic, a conduit heat flux, or a combination thereof. In one form, the one or more mathematical-based variables and the one or more machine learning-based variables indicate an upstream temperature and a downstream temperature relative to a sensor from among the one or more sensors configured to generate the sensor data.

The present disclosure provides a system including one or more processors and one or more nontransitory computer-readable mediums comprising instructions that are executable by the one or more processors. The instructions include generating one or more mathematical-based variables based on a mathematical model of an environment and sensor data from one or more sensors of the environment and generating one or more machine learning-based variables based on a machine learning-based model of the environment and the sensor data. The instructions include stacking the one or more mathematical-based variables and the one or more machine learning-based variables based on a meta-learning model to generate a machine learning input, where the machine learning input includes a material deposit characteristic machine learning (MDCML) input, a sensor characteristic machine learning (SCML) input, a heater characteristic machine learning (HCML) input, or a combination thereof. The instructions include predicting a performance characteristic of the environment based on the machine learning input, where the performance characteristic of the environment includes an amount of material deposit within a conduit of the environment based on the MDCML input, a sensor state of the one or more sensors based on the SCML input, a heater state of a heater of the environment based on the HCML input, or a combination thereof.

The following paragraph includes variations of the system of the above paragraph, which may be implemented individually or in any combination.

In one form, the mathematical model is a thermodynamic model of the environment. In one form, the machine learning-based model is one of a random forest regression model and a gradient boosting regression model. In one form, the gradient boosting regression model is a support vector machine regression model. In one form, the meta-learning model is a gradient boosting regression model. In one form, the sensor data indicates a gas flow rate, a gas temperature, a conduit temperature, a heater characteristic, a conduit heat flux, or a combination thereof. In one form, the one or more mathematical-based variables and the one or more machine learning-based variables indicate an upstream temperature and a downstream temperature relative to a sensor from among the one or more sensors configured to generate the sensor data.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an example environment in accordance with the teachings of the present disclosure;

FIG. 2 is a functional block diagram of an environment characteristic system in accordance with the teachings of the present disclosure;

FIG. 3 is a flowchart of an example routine for generating a digital twin of the environment in accordance with the teachings of the present disclosure; and

FIG. 4 is a graph illustrating a mean absolute percentage of error of one or more modules in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure generally provides a digital twin module for generating a digital twin of an environment based on sensor data of the environment. As used herein, “digital twin” refers to a virtual representation of the environment, a component or system thereof, and/or a performance characteristic of the component, system, and/or environment based on the sensor data (e.g., an upstream/downstream temperature of a conduit, a material buildup of a conduit, among others). To generate the digital twin, the digital twin module generates a plurality of predicted variables based on a mathematical-based model, one or more machine learning models, and the sensor data. The digital twin module then employs a stacking/ensemble machine learning model that stacks the predicted variables to generate the digital twin. Accordingly, the digital twin module creates the digital twin with less time and using fewer resources (i.e., less sensors and less data are needed to generate the digital twin) compared to a conventional, data-driven machine learning or a mathematical-based approach.

The present disclosure also provides a characteristic module configured to predict a state of the environment/component based on the performance characteristic. As an example, the characteristic module is a machine learning system that is configured to determine the semiconductor processing system has a fault or anomaly in response to the predicted material buildup being greater than a threshold amount and/or the predicted material buildup occurring in advance of a time/date associated with the predicted material buildup. As another example, the characteristic module is configured to determine the semiconductor processing system has a fault or anomaly in response to the upstream/downstream temperature of the conduit satisfying one or more temperature conditions, as described below in further detail.

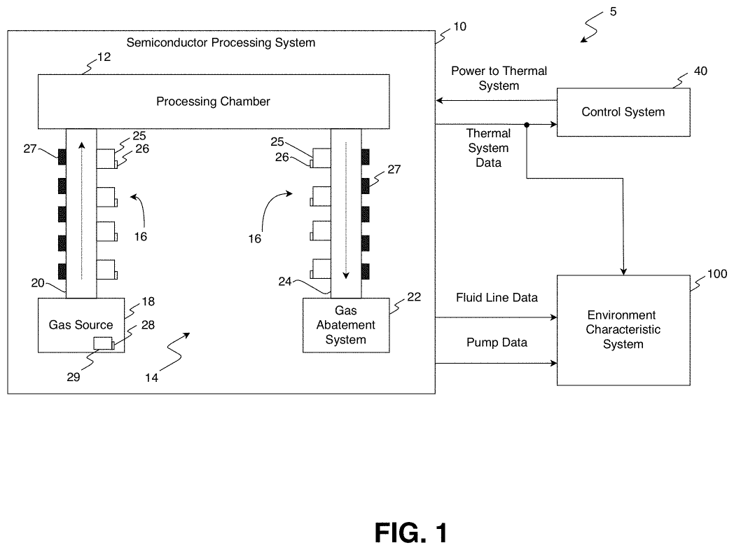

Referring to FIG. 1, an environment characteristic system 100 for monitoring and controlling an environment 5 is shown. In one form, the environment 5 includes a semiconductor processing system 10 and a control system 40. In one form, the semiconductor processing system 10, the control system 40, and the environment characteristic system 100 are communicably coupled using a wired communication protocol and/or a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). It should be understood that the environment 5 may include other types of systems and is not limited to the examples described herein. For example, the environment 5 may include other industrial and manufacturing processes/systems, such as machining processes, injection molding processes, combustion exhaust systems, heating, ventilation, and air conditioning systems (HVAC systems), among others.

In one form, the semiconductor processing system 10 generally includes a processing chamber 12, a gas delivery system 14, and a thermal system 16. In one form, the gas delivery system 14 includes a gas source 18, a gas supply line 20 for delivering process gases from the gas source 18 to the processing chamber 12, a gas abatement system 22, and an exhaust line 24 for delivering exhaust gases from the processing chamber 12 to the gas abatement system 22, such as post-process gases, by-products of the gas/plasma, and/or waste associated with the wafer. In one form, the process gases used in semiconductor wafer processing may be toxic, pyrophoric, or corrosive (e.g., fluoride, ammonia, silane, argon, arsine, and/or phosphine, among other gases). In some forms, unused process gases (e.g., argon or nitrogen) and hazardous by-products are delivered to the gas abatement system 22, where the unused process gases and by-products are cleansed and neutralized prior to being released to the environment. In the following, process gases and exhaust gases may collectively be referred to as “gas.” Furthermore, the gas supply line 20 and the exhaust line 24 may be collectively or individually referred to herein as a “conduit.”

In one form, the thermal system 16 includes a plurality of heaters 25 that are disposed at different locations along the gas supply line 20 and the exhaust line 24 to heat gases flowing in the gas supply line 20 and the exhaust line 24. In one form, the heaters 25 are flexible heaters wrapped about the gas supply line 20 and the exhaust line 24 to heat the gas therein. In another example, the heaters 25 are electric heaters that heat the gas flowing through the gas supply line 20 and the exhaust line 24. Heating the gas as it is delivered from the process chamber 12 and to the gas abatement system 22 facilitates wafer processing in the process chamber 12 and the exhaust gas treatment in the gas abatement system 22. Furthermore, heating the gas inhibits contaminants from depositing along the walls of the gas supply line 20 and the exhaust line 24 and therefore inhibits clogging in the gas supply line 20 and the exhaust line 24.

In one form, the thermal system 16 includes a plurality of thermal sensors 26 for measuring thermal system data that includes, but is not limited to, a temperature of the heater 25, heat flux of the heater 25, electrical characteristic data of the heater 25 (e.g., a voltage, an electric current, an electrical power, and/or a resistance of the heater 25), among others. The plurality of thermal sensors 26 may include a thermocouple, a resistance temperature detector, an infrared camera, a current sensor, and/or a voltage sensor, among others.

In one form, the plurality of heaters 25 may generate the performance characteristic in lieu of or in addition to the one or more thermal sensors 26 generating the performance characteristics. As an example, the heater 25 is provided as a two-wire heater that includes one or more resistive heating elements that operate as a sensor for measuring an average temperature of the resistive heating element based on a resistance of the resistive heating element. More particularly, such a two-wire heater is disclosed in U.S. Pat. No. 7,196,295, which is commonly owned with the present application and the contents of which are incorporated herein by reference in its entirety. In a two-wire thermal system, the thermal system 16 is an adaptive thermal system that merges heater designs with controls that incorporate power, resistance, voltage, and current in a customizable feedback control system that limits one or more of these parameters (i.e., power, resistance, voltage, and current) while controlling another. In one form, the controller is configured to monitor at least one of current, voltage, and power delivered to the resistive heating element to determine the resistance and temperature of the resistive heating element.

In one form, the gas delivery system 14 includes a plurality of fluid line sensors 27 disposed proximate to (i.e., adjacent and/or near) the gas supply line 20 and the exhaust line 24 for measuring fluid line data. As an example, the fluid line sensors 27 are mounted to the gas supply line 20 and the exhaust line 24 to monitor for cold spots that may cause clogging, heat sinks, and hot spots that lead to system degradation and downtime. In one form, the fluid line data may include, but is not limited to, a temperature of the gas supply line 20/exhaust line 24, flow rate and pressure of the gases, and the types of process gases. Accordingly, the fluid line sensors 27 may include, but are not limited to, temperature sensors, pressure sensors, flow rate meters, and gas sensors, among others.

In one form, the gas delivery system 14 includes a pump sensor 28 disposed proximate a pump 29 of the gas source 18 for measuring pump data, such as an electrical characteristic of the pump 29 (e.g., a voltage, current, power, etc.), pressure of the pump 29, and/or temperature of the pump. Accordingly, the pump sensor 28 may include a voltage sensor, current sensor, pressure sensor, and/or temperature sensor configured to measure the pump data. In one form, the pump 29 is configured to remove exhaust gas from the processing chamber 12 to the gas abatement system 22. In some forms, the pump data may be provided to the semiconductor control system 13 to control the operation of the semiconductor processing system 10, as described below in further detail.

In one form, the control system 40 is configured to control the electrical power provided to the thermal system 16 based on defined control process and/or a user input received from a user interface device of the control system 40 (e.g., a human machine interface (HMI)). As an example, the control system 40 may employ a proportional-integral-derivative (PID) control routine, a model predictive control routine, a cascade control routine, or a differential control routine, as the defined control process, to adjust the electrical power provided to thermal system 16 based on thermal sensor data and therefore adjust the temperature of at least one of the heaters 25.

In one form, when the heaters 25 are heaters have a sufficiently high temperature coefficient of resistance (TCR), the control system 40 is configured to determine the performance characteristics based on the resistance of a resistive heating element of the heaters 25. As an example, when the heaters 25 are two-wire heaters, the control system 40 is provided as a two-wire control system. Typically, in a two-wire system, the resistive heating elements are defined by a material that exhibits a varying resistance with varying temperature such that an average temperature of the resistive heating element is determined based on a change in resistance of the resistive heating element. In one form, the resistance of the resistive heating element is calculated by first measuring the voltage across and the current through the heating elements, and then, using Ohm's law, the resistance is determined. In one form, a resistance-temperature association (e.g., algorithm, look-up table, among others) is employed to determine the temperature based on the resistance. The two-wire control system is configured to perform one or more control processes to determine the desired power to be applied to the heaters. Example two-wire control system and associated control processes are described in U.S. Pat. No. 10,690,705 filed Jun. 15, 2017, and titled “POWER CONVERTER FORA THERMAL SYSTEM” and U.S. Pat. No. 10,908,195 filed Aug. 10, 2018, and titled “SYSTEM AND METHOD FOR CONTROLLING POWER TO A HEATER, which is commonly owned with the present application and the contents of which are incorporated herein by reference in its entirety.

In one form, the environment characteristic system 100 obtains the thermal system data, the fluid line data, and the pump data from the semiconductor processing system 10 (collectively referred to herein as “sensor data”) and generates a digital twin of the environment 5. As used herein, “digital twin” refers to a virtual representation of the environment 5, a component thereof, and/or performance characteristics of a component thereof. As described herein, the environment characteristic system 100 is configured to generate a digital twin by generating one or more mathematical-based variables based on a mathematical model of the environment 5 and the sensor data. Additionally, the environment characteristic system 100 is configured to generate one or more machine learning-based variables based on a machine learning-based model of the environment and the sensor data. Furthermore, the environment characteristic system 100 employs a meta-learning model that stacks the one or more mathematical-based variables and the one or more machine learning-based variables based to generate a digital twin that is provided to a machine learning system configured to predict an operational/performance characteristic of the environment 5.

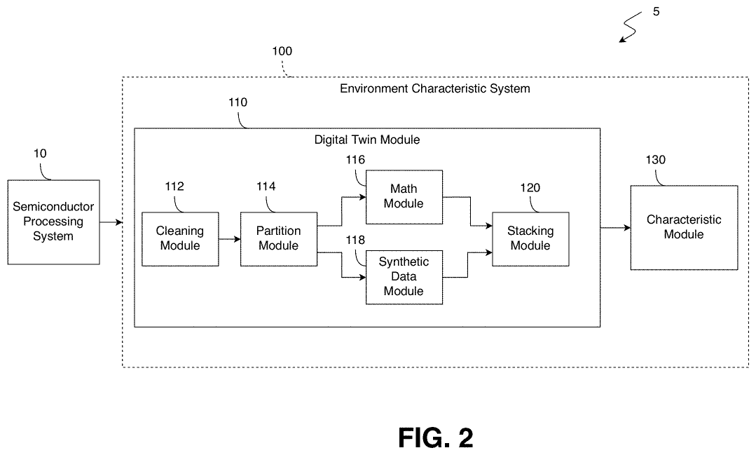

Referring to FIG. 2, the environment characteristic system 100 includes a digital twin module 110 and a characteristic module 130. The digital twin module 110 includes a cleaning module 112, a partition module 114, a math module 116, a synthetic data module 118, and a stacking module 120. It should be readily understood that any one of the modules of the environment characteristic system 100 can be provided at the same location or distributed at different locations (e.g., via one or more edge computing devices) and communicably coupled accordingly.

In one form, the cleaning module 112 is configured to perform known data correction routines to detect and repair errors of the sensor data to enhance the accuracy of the variables generated by the math module 116 and the synthetic data module 118. In one form, the partition module 114 is configured to partition the cleaned sensor data into multiple sets of sensor data (e.g., training data and validation data) using known sample splitting routines, such as a k-fold cross-validation routine or other types of out-of-fold prediction routines.

In one form, the math module 116 is configured to generate one or more mathematical-based variables based on a mathematical model of the environment 5 (e.g., the semiconductor processing system 10 or a component thereof) and a set of the sensor data. In one form, the mathematical model is a thermodynamic model (e.g., one or more thermodynamic equations) and/or a physics-based model that predict(s) the one or more mathematical-based variables associated with one or more components of the environment 5, such as the heater 25, the processing chamber 12, and/or the gas delivery system 14. In one form, the math module 116 generates the mathematical model based on the sensor data, the desired type of data to be provided to the characteristic module 130, the type of components of the environment 5, among others.

The mathematical-based variables may indicate a temperature/heat flux (e.g., upstream and downstream temperatures/heat flux of the gas supply line 20 relative to one of the fluid line sensors 27, peak temperatures of the gas supply line 20, temperature data associated with the exhaust line 24, among others); a cool down time of the gas supply line 20 or exhaust line 24 when it is subjected to a predefined amount of heat for a given period of time; clogging in the gas supply line 20 or exhaust line 24; and/or electrical characteristics of the heaters 25 (e.g., voltage, current, resistance, power, among others). Additionally or alternatively, the mathematical-based variables may indicate thermodynamic properties of the gas supply line 20, the exhaust line 24, and/or a gas flowing therein (e.g., enthalpy, entropy, exergy, among others). Additionally or alternatively, the mathematical-based variables may indicate transport properties of the semiconductor processing system 10 (e.g., viscosity, thermal conductivity, surface tension, among others), volumetric properties of the semiconductor processing system 10, among others.

As an example, the math module 116 performs a virtual sensing routine to measure the temperature of the exhaust line 24 by obtaining one or more inputs from the heaters 25, including, but not limited to: mass flow rate, flow velocity, flow temperature either upstream or downstream of the heaters 25, heater power input, and parameters derived from the physical characteristics of the heaters 25. Example parameters derived from the physical characteristics of the heaters 25 include, but are not limited to: a resistance wire diameter, an insulation thickness, a sheath thickness, conductivity, specific heat and density of the materials, heat transfer coefficient, emissivity of the heater 25, among other geometrical and application-related parameters. The math module 116 may measure the temperature characteristics of the exhaust line 24 based on a mathematical model and the one or more inputs. Example virtual sensing routines to measure the temperature of the exhaust line 24 using the one or more inputs and a mathematical model are disclosed in U.S. Pat. No. 10,544,722, and titled “VIRTUAL SENSING SYSTEM,” which is commonly owned with the present application and the contents of which are incorporated herein by reference in its entirety.

In one form, the synthetic data module 118 is configured to generate one or more machine learning-based variables based on one or more machine learning models of the environment 5 (e.g., the semiconductor processing system 10 or a component thereof) and one or more sets of the sensor data. As an example, the synthetic data module 118 may generate the machine learning-based variable based on a machine learning regression model, such as a random forest regression model, a gradient boosting regression model (e.g., an XGBoost gradient boosting regression model, a CatBoost gradient boosting regression model, a support vector machine regression model, among others), a neural network regression model, among other types of machine learning regression models. It should be understood that the synthetic data module 118 may employ any type of supervised machine learning model and/or deep learning model and is not limited to the examples described herein.

As an example, the one or more machine learning models of the synthetic data module 118 may include a convolutional neural network regression model that instructs the heaters 25 to provide thermal energy to the gas supply line 20 and/or the exhaust line 24 in steps, or in ramps, with periodic or aperiodic timing and/or varying amplitudes. The convolutional neural network may then express resulting behaviors due to unknown model parameters (e.g., power output by the heaters 25, gas flow within the gas supply line 20 and/or the exhaust line 24, gas pressure within the gas supply line 20 and/or the exhaust line 24, among others) as a thermal response. As a specific example, the convolutional neural network may correlate known quantities and/or distribution of materials on a surface of the gas supply line 20 and/or the exhaust line 24 to changes in a thermal characteristic of the gas supply line 20 and/or the exhaust line 24. Example thermal characteristics of the gas supply line 20 and/or the exhaust line 24 include, but are not limited to, an emissivity of the gas supply line 20 and/or the exhaust line 24, thermal coupling between different portions or zones of the gas supply line 20 and/or the exhaust line 24, thermal gains of the gas supply line 20 and/or the exhaust line 24, and gas convective coupling of the gas supply line 20 and/or the exhaust line 24. Example machine learning models for predicting coking of the gas supply line 20 and/or the exhaust line 24 are disclosed in U.S. patent application Ser. No. 17/306,200, and titled “METHOD OF MONITORING A SURFACE CONDITION OF A COMPONENT,” which is commonly owned with the present application and the contents of which are incorporated herein by reference in its entirety.

In one form, the parameters of the machine learning regression model(s) of the synthetic data module 118 are defined using known training routines and one or more sets of the sensor data. For example, a random forest regression model, an XGBoost gradient boosting regression model, a CatBoost gradient boosting regression model, and/or a support vector machine regression model are trained using the training data from among the cleaned sensor data partitioned by the partition module 114.

In one form, the machine learning-based variables generated by the synthetic data module 118 are similar to the mathematical-based variables (collectively referred to hereinafter as “predicted variables”). In one form, the predicted variables indicate an error associated with the outputs generated by the respective model relative to the sensor data (e.g., the ground truth). As an example, the error is represented as a mean absolute error and/or a mean absolute percentage of error between the predicted upstream/downstream temperatures relative to one of the fluid line sensors 27 and a measured upstream/downstream temperature using another one of the fluid line sensors 27. As another example, the error is represented as a mean absolute error and/or a mean absolute percentage of the error between the predicted material buildup within the gas supply line 20 and a known material buildup within the gas supply line 20. It should be understood that other types of metrics may be employed to indicate an error associated with the respective model relative to the sensor data, such as a sum of mean absolute errors over time, a mean absolute scaled error, a mean squared error, a least absolute deviation error, a root-mean square error, among other metrics indicative of the error.

In one form, the stacking module 120 is configured to stack the predicted variables based on a meta-learning model and the validation data to generate a digital twin that is provided to the characteristic module 130 as a machine learning input. As used herein, “stacking” refers to selectively combining the predicted variables (i.e., the machine learning-based variables and the mathematical-based variables) using an ensemble routine (as the meta-learning model) to generate a refined prediction corresponding to the machine learning input. In one form, the stacking module 120 employs a gradient boosting regression model (as the meta-learning model) that generates the digital twin by selectively combining the predicted variables based on a k-fold cross-validation routine, where “k” is equal to the sum of the number of machine learning models of the synthetic data module 118 and the mathematical model. It should be understood that the stacking module 120 may employ a linear regression model to stack the predicted variables in other forms. As an example, the stacking module 120 stacks the predicted variables to generate a digital twin that represents a material deposit characteristic machine learning (MDCML) input associated with one of the conduits, a heater characteristic machine learning (HCML) input associated with one of the heaters 25, and/or a sensor characteristic machine learning (SCML) input associated with the sensor data.

In one form, the characteristic module 130 is configured to predict a performance characteristic of the environment 5 or a component thereof based on the digital twin generated by the stacking module 120 (e.g., at least one of the MDCML, HCML, and SCML inputs). In one form, the characteristic module 130 employs a binary classification system and/or machine learning model that is configured to determine whether the semiconductor processing system 10 has a fault/anomaly. As an example, the characteristic module 130 determines whether the MDCML input indicates a material buildup within the gas supply line 20 and/or the exhaust line 24 that is greater than a threshold amount and/or occurs in advance of a time/date associated with a predicted material buildup. As another example, the characteristic module 130 determines whether the HCML input indicates a heater failure 25 based on a performance/electrical characteristic of the heater and/or an upstream/downstream temperature of the gas supply line 20 and/or the exhaust line 24 satisfying one or more temperature conditions, such as a predetermined temperature differential, temperature thresholds, among others. As an additional example, the characteristic module 130 determines whether the SCML input indicates a sensor failure of one of the fluid line sensors 27.

The characteristic module 130 is configured to perform one or more corrective actions based on the predicted performance characteristic. In one form, the characteristic module 130 is configured to broadcast, via one or more server computing devices, a command to a remote computing device executing an application (e.g., a smartphone, a laptop, a desktop computing device, a tablet, among other types of computing devices) to generate one or more alerts for notifying a technician/operator of the predicted performance characteristic and/or initiating one or more types of corrective actions.

As an example, the characteristic module 130 broadcasts a command to a tablet device executing the application to display one or more graphical user interface elements corresponding to a given fluid line sensor 27 that has failed (as indicated by the SCML input) and instructions for replacing the given fluid line sensor 27. As another example, the characteristic module 130 broadcasts a command to a tablet device executing the application to display a virtual representation of the exhaust line 24 and one or more graphical user interface elements corresponding to a location and/or amount of the clogging within the exhaust line 24 (as indicated by the MDCML input). Example systems and methods for generating virtual representations of the exhaust line 24 are disclosed in U.S. patent application Ser. No. 17/089,447, and titled “CONTROL AND MONITORING SYSTEM FOR GAS DELIVERY SYSTEM,” which is commonly owned with the present application and the contents of which are incorporated herein by reference in its entirety.

As yet another example, the characteristic module 130 is configured to command the control system 40 to adjust the operation of the heater 25 (e.g., increase or decrease power provided to the heater 25) based on the predicted performance characteristics (as indicated by the HCML input). More particularly, the control system 40 may perform one or more process control routines based on the predicted performance characteristics.

An example process control routine is disclosed in U.S. Pat. No. 10,908,195, filed Aug. 10, 2018, and titled “SYSTEM AND METHOD FOR CONTROLLING POWER TO A HEATER,” which is commonly owned with the present application and the contents of which are incorporated herein by reference in its entirety. In this example, the control system 40 is configured to select a state model control defining one or more operation settings of the heater (e.g., a power-up control, a soft start control, a set rate control, and a steady-state control) and control the power supplied to the heater 25 based on the state model control and the electrical characteristic of the heater (as the predicted performance characteristic).

Another example process control routine is disclosed in co-pending application, U.S. Ser. No. 16/294,201, filed Mar. 6, 2019, and titled “CONTROL SYSTEM FOR CONTROLLING A HEATER,” which is commonly owned with the present application and the contents of which are incorporated herein by reference in its entirety. In this example, the control system 40 includes two or more auxiliary controllers that control power to a plurality of heater zones of defined by the heaters 25 based on the predicted performance characteristics of the heaters 25. Furthermore, the control system 40 includes a primary controller that provides an operation set-point for each heater zone based on the predicted performance characteristics.

An additional example process control routine is disclosed in co-pending application, U.S. Ser. No. 16/568,757, filed Sep. 12, 2019, and titled “SYSTEM AND METHOD FOR A CLOSED-LOOP BAKE-OUT CONTROL,” which is commonly owned with the present application and the contents of which are incorporated herein by reference in its entirety. In this example, the control system 40 includes a controller that determines an operational power level based on the predicted performance characteristic, a power set-point, and a power control algorithm, and the controller is configured to determine a bake-out power level. The controller selects a power level to be applied to the heater 25 based on the lower level from among the operational power level and the bake-out power level.

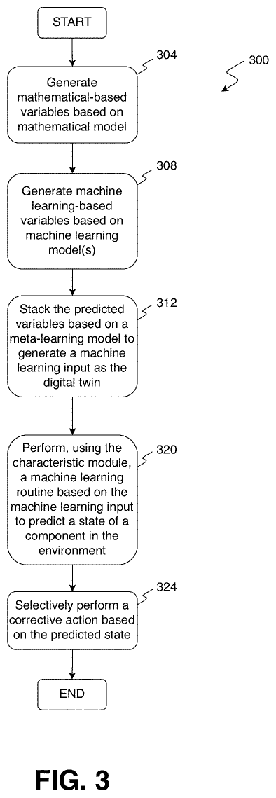

Referring to FIG. 3, a flowchart of a routine 300 for generating a digital twin of the environment 5 and processing the digital twin is shown. At 304, the math module 116 generates one or more mathematical-based variables based on a mathematical model of the environment 5 (e.g., a thermodynamic model) and a set of the sensor data. At 308, the synthetic data module 118 generates one or more machine learning-based variables based on one or more machine learning models of the environment 5 and one or more sets of the sensor data. It should be understood that step 308 may be performed prior to step 304 or in parallel with step 304 in other forms. At 312, the stacking module 120 stacks the predicted variables based on a meta-learning model and validation data to generate a machine learning input as the digital twin (e.g., the MDCML, HCML, and/or SCML inputs). At 320, the characteristic module 130 performs a machine learning routine based on the machine learning input to predict a state of a component of the environment 5 based on the digital twin. At 324, the characteristic module 130 selectively performs a corrective action based on the predicted state (e.g., generates a notification/alert using an HMI or other display device).

By stacking the predicted variables based on the meta-learning model and the validation data to generate the MDCML, HCML, and/or SCML inputs (i.e., the machine learning input), the characteristic module 130 predicts a state of the environment 5 or a component thereof with enhanced accuracy compared to using one of the predicted variables. Specifically, the error value of the machine learning input is less than the error value of the predicted variables.

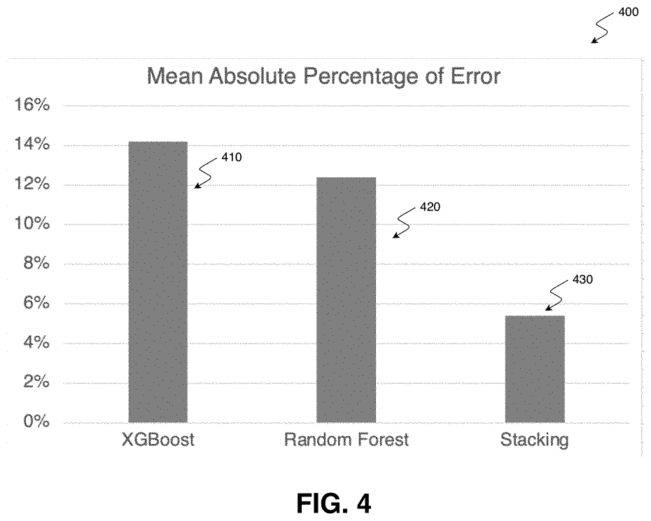

As an example and as shown in bar chart 400 of FIG. 4, a mean absolute percentage of error of the predicted variable (e.g., a kurtosis of the heat flux of the gas supply line 20 relative to one of the fluid line sensors 27) output by the XGBoost gradient boosting regression model (as one of the machine learning regression models of the synthetic data module 118) is approximately 14.2%, as indicated by plot 410. Furthermore, the mean absolute percentage of error of the predicted variable output by the random forest regression model (as one of the machine learning regression models of the synthetic data module 118) is approximately 12.1%, as indicated by plot 420. Additionally, the mean absolute percentage of error of the HCML output by the stacking module 120 (e.g., an output of the stacking routine associated with each of the kurtosis of the heat flux generated by each of the machine learning regression models of the synthetic data module 118) is approximately 5.4%, as indicated by plot 430. Accordingly, the characteristic module 130 predicts a state of the environment 5 or a component thereof with enhanced accuracy when using the machine learning input as opposed to using one of the predicted variables due to the reduced error associated with the machine learning input.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons, including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term controller or module may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality, such as, but not limited to, movement drivers and systems, transceivers, routers, input/output interface hardware, among others; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

What is claimed is:

1. A method of generating a digital twin of an environment comprising:
generating one or more mathematical-based variables based on a mathematical model of the environment and sensor data from one or more sensors of the environment;
generating one or more machine learning-based variables based on a machine learning-based model of the environment and the sensor data; and
stacking the one or more mathematical-based variables and the one or more machine learning-based variables based on a meta-learning model to generate a machine learning input for predicting a performance characteristic of the environment.

2. The method according to claim 1, wherein the mathematical model is a thermodynamic model of the environment.

3. The method according to claim 1, wherein the machine learning-based model is one of a random forest regression model and a gradient boosting regression model.

4. The method according to claim 3, wherein the gradient boosting regression model is a support vector machine regression model.

5. The method according to claim 1, wherein the meta-learning model is a gradient boosting regression model.

6. The method according to claim 1, wherein the sensor data indicates a gas flow rate, a gas temperature, a conduit temperature, a heater characteristic, a conduit heat flux, or a combination thereof.

7. The method according to claim 1, wherein the one or more mathematical-based variables and the one or more machine learning-based variables indicate an upstream temperature and a downstream temperature relative to a sensor from among the one or more sensors configured to generate the sensor data.

8. A method comprising:
generating one or more mathematical-based variables based on a mathematical model of an environment and sensor data from one or more sensors of the environment;
generating one or more machine learning-based variables based on a machine learning-based model of the environment and the sensor data;
stacking the one or more mathematical-based variables and the one or more machine learning-based variables based on a meta-learning model to generate a machine learning input, wherein the machine learning input includes a material deposit characteristic machine learning (MDCML) input, a sensor characteristic machine learning (SCML) input, a heater characteristic machine learning (HCML) input, or a combination thereof; and
predicting a performance characteristic of the environment based on the machine learning input, wherein the performance characteristic of the environment includes an amount of material deposit within a conduit of the environment based on the MDCML input, a sensor state of the one or more sensors based on the SCML input, a heater state of a heater of the environment based on the HCML input, or a combination thereof.

9. The method according to claim 8, wherein the mathematical model is a thermodynamic model of the environment.

10. The method according to claim 8, wherein the machine learning-based model is one of a random forest regression model and a gradient boosting regression model.

11. The method according to claim 10, wherein the gradient boosting regression model is a support vector machine regression model.

12. The method according to claim 8, wherein the meta-learning model is a gradient boosting regression model.

13. The method according to claim 8, wherein the sensor data indicates a gas flow rate, a gas temperature, a conduit temperature, a heater characteristic, a conduit heat flux, or a combination thereof.

14. The method according to claim 8, wherein the one or more mathematical-based variables and the one or more machine learning-based variables indicate an upstream temperature and a downstream temperature relative to a sensor from among the one or more sensors configured to generate the sensor data.

15. A system comprising:
one or more processors; and
one or more nontransitory computer-readable mediums comprising instructions that are executable by the one or more processors, wherein the instructions comprise:
generating one or more mathematical-based variables based on a mathematical model of an environment and sensor data from one or more sensors of the environment;
generating one or more machine learning-based variables based on a machine learning-based model of the environment and the sensor data;
stacking the one or more mathematical-based variables and the one or more machine learning-based variables based on a meta-learning model to generate a machine learning input, wherein the machine learning input includes a material deposit characteristic machine learning (MDCML) input, a sensor characteristic machine learning (SCML) input, a heater characteristic machine learning (HCML) input, or a combination thereof; and
predicting a performance characteristic of the environment based on the machine learning input, wherein the performance characteristic of the environment includes an amount of material deposit within a conduit of the environment based on the MDCML input, a sensor state of the one or more sensors based on the SCML input, a heater state of a heater of the environment based on the HCML input, or a combination thereof.

16. The system according to claim 15, wherein the mathematical model is a thermodynamic model of the environment.

17. The system according to claim 15, wherein the machine learning-based model is one of a random forest regression model and a gradient boosting regression model.

18. The system according to claim 15, wherein the meta-learning model is a gradient boosting regression model.

19. The system according to claim 15, wherein the sensor data indicates a gas flow rate, a gas temperature, a conduit temperature, a heater characteristic, a conduit heat flux, or a combination thereof.

20. The system according to claim 15, wherein the one or more mathematical-based variables and the one or more machine learning-based variables indicate an upstream temperature and a downstream temperature relative to a sensor from among the one or more sensors configured to generate the sensor data.
